(19) United States
(12) Patent Application Publication
(10) Pub. No.: US 2015/0160510 A1
(43) Pub. Date: Jun. 11, 2015

(54) LIQUID CRYSTAL DISPLAY DEVICE

(71) Applicant: Japan Display Inc., Minato-ku (JP)

(72) Inventors: Takashi Mitsumoto, Tokyo (JP); Kazuhiro Joten, Tokyo (JP)

(73) Assignee: Japan Display Inc., Minato-ku (JP)

(21) Appl. No.: 14/562,929

(22) Filed: Dec. 8, 2014

(30) Foreign Application Priority Data
Dec. 9, 2013 (JP) 2013-253830

(51) Int. Cl. G02F 1/1335; G02F 1/13363

(52) U.S. Cl. CPC G02F 1/133528; G02F 1/13363; G02F 2202/28

(57) ABSTRACT

According to one embodiment, a liquid crystal display device includes a liquid crystal display panel in which a liquid crystal layer is held between a first glass substrate and a second glass substrate which are located opposite to each other, a first optical element including a first supporting layer provided on an outer surface side of the first glass substrate, a first polarizer layer stacked on the first supporting layer and a first adhesion layer adhering the first supporting layer, and a second optical element including a second supporting layer, a second polarizer layer, and a second adhesion layer, wherein the first supporting layer and the first adhesion layer are each formed of material which does not cause an oxidization-reduction action.

### CROSS-REFERENCE TO RELATED APPLICATIONS

This application is based upon and claims the benefit of priority from Japanese Patent Application No. 2013-253830, filed Dec. 9, 2013, the entire contents of which are incorporated herein by reference.

### FIELD

Embodiments described herein relate generally to a liquid crystal display device.

### BACKGROUND

Liquid crystal display devices are used as display devices in various kinds of fields. In recent years, liquid crystal display devices have been more highly required to maintain a certain display quality of an image even in an environment of high temperature and high humidity.

On the other hand, it is known as a technique that in a laminated body (optical element), a protection layer is provided at a light transmissive base (supporting layer) formed of cycloolefinpolymer or the like to maintain a certain display quality of an image.

### BRIEF DESCRIPTION OF THE DRAWINGS

FIG. 1 is a view schematically showing an equivalent circuit and a configuration of a display panel PNL included in a liquid crystal display device according to an embodiment;

FIG. 2 is a schematic plan view showing a pixel structure of an array substrate AR as shown in FIG. 1, as viewed from a counter-substrate CT side;

FIG. 3 is a cross-sectional view schematically showing a structure of the display panel PNL included in the liquid crystal display device according to the embodiment;

FIG. 4 is a cross-sectional view schematically showing structures of a first optical element OD1 and a second optical element OD2 in the embodiment;

FIG. 5 is a view schematically showing an example of a formation process of a bright spot;

FIG. 6 is a view for explaining a result of an experiment with respect to a comparative example and embodiments; and

FIG. 7 is a cross-sectional view schematically showing structures of optical elements in a modification of the embodiment.

### DETAILED DESCRIPTION

In general, according to one embodiment, a liquid crystal display device comprising:
a liquid crystal display panel in which a liquid crystal layer is held between a glass first substrate and a second glass substrate which are located opposite to each other;
a first optical element including a first supporting layer, a first polarizer layer and a first adhesion layer, the first supporting layer being provided on an outer surface side of the first glass substrate, the first polarizer layer being stacked on the first supporting layer, the first adhesion layer adhering the first supporting layer to the outer surface side of the first glass substrate; and
a second optical element including a second supporting layer, a second polarizer layer and a second adhesion layer, the second supporting layer being provided on an outer surface side of the second glass substrate, the second polarizer layer being stacked on the second supporting layer, the second adhesion layer adhering the second supporting layer to the outer surface side of the second glass substrate,
wherein the first supporting layer and the first adhesion layer are each formed of material which does not cause an oxidization-reduction action.

Embodiments will be described hereinafter with reference to the accompanying drawings. It should be noted that they are disclosed as mere examples; and needless to say, if they are modified as appropriate by a person with ordinary skill in the art without changing the subject matter of the invention, such modifications fall within the scope of the invention as long as they can be easily conceived by a person with ordinary skill in the art. Furthermore, in the drawings, there is a case where portions are schematically depicted in with, thickness, shape, etc., in order that an explanation be more clearly given, and such depiction is a mere example, and does not limit an interpretation of the present invention. In addition, in the specification and the figures, after a structural element or elements are described with reference to a figure or figures, structural elements identical to the above described structural elements or having the same or similar functions to those thereof will be denoted by the same reference numerals, respectively, and there is a case where their explanations will not be repeated.

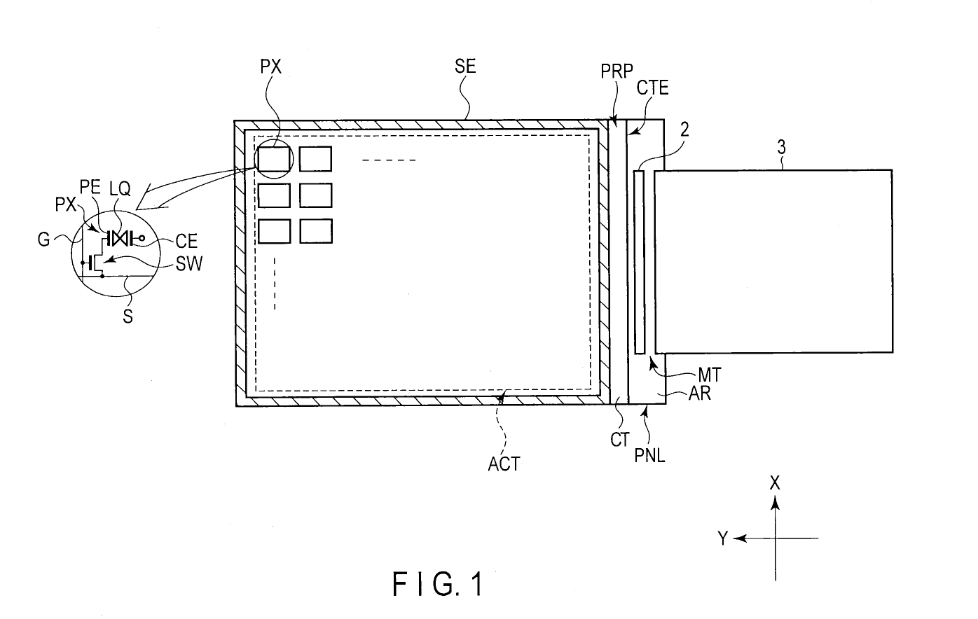

FIG. 1 is a view schematically showing an equivalent circuit and a configuration of a display panel PNL included in a liquid crystal display device according to an embodiment.

To be more specific, the display panel PNL is an active matrix transmissive type of liquid crystal display panel, and comprises an array substrate AR, a counter-substrate CT provided opposite to the array substrate AR and a liquid crystal layer LQ held between the array substrate AR and the counter-substrate CT. The array substrate AR and the counter-substrate CT are bonded to each other by a seal material SE, with a predetermined cell gap provided between the array substrate AR and the counter-substrate CT. In an example shown in FIG. 1, the seal material SE is formed in the shape of a rectangular frame and in a manner of a closed loop. The cell gap is provided by a pillar spacer not shown which is provided in the array substrate AR or the counter-substrate CT. In the cell gap between the array substrate AR and the counter-substrate CT, the liquid crystal layer LQ is held within an area surrounded by the seal material SE. The display panel PNL includes an active area ACT for displaying an image, within the area surrounded by the seal material SE. The active area ACT is, e.g., substantially rectangular, and comprises a plurality of pixels PX arranged in a matrix.

In the active area ACT, the array substrate AR comprises gate lines G extending in a first direction X, source lines S extending in a second direction Y perpendicular to the first direction X, switching elements SW electrically connected to gate lines G and source lines S in pixels PX, respectively, and pixel electrodes PE connected to the switching elements SW in the pixels PX, respectively. A Common electrode CE having a common potential is provided in the array substrate AR or the counter-substrate CT, and opposite to the pixel electrodes PE, with the liquid crystal layer LQ interposed between the common electrode CE and the pixel electrodes PE.

It should be noted that although a detail explanation of the structure of the display panel PNL will be omitted, in a mode primarily using a vertical electric field such as a twisted nematic (TN) mode, an optically compensated bend (OCB) mode or a vertical aligned (VA) mode, the pixel electrodes PE are provided in the array substrate AR, and a common electrode CE is provided in the counter-substrate CT. Furthermore, in a mode primarily using a horizontal electric field such as an in-plane switching (IPS) mode or a fringe field switching (FFS) mode, the pixel electrodes PE and the common electrode CE are both provided in the array substrate AR.

Signal supply sources necessary to drive the display panel PNL, which are a drive IC chip 2, a flexible printed circuit (FPC) substrate 3, etc., are provided in a peripheral area PRP located outward of the active area ACT. In the example shown in FIG. 1, the drive IC chip 2 and the FPC substrate 3 are mounted on a mounting portion MT of the array substrate AR, which is located outward of a substrate end portion CTE of the counter-substrate CT. The peripheral area PRP is an area surrounding the active area ACT, includes an area where the seal material SE is provided, and is formed in the shape of a rectangular frame.

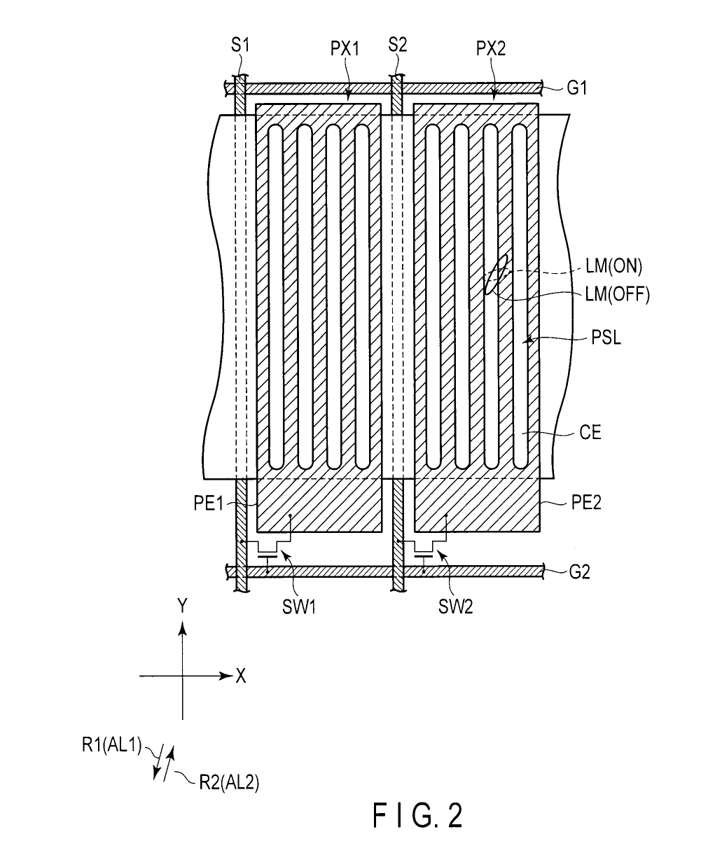

FIG. 2 is a schematic plan view showing the array substrate AR as shown in FIG. 1, as viewed from a counter-substrate CT side. It should be noted that in the following explanation, a pixel structure to which the FFS mode is applied will be described by way of example, the FFS mode being provided as a mode using a horizontal electric field; and FIG. 2 shows only main portions which need to be referred to in the explanation. For example, a pixel PX1 and a pixel PX2 arranged side by side in the first direction X are pixels having different colors.

A gate line G1 and a gate line G2 extend in the first direction X. A source line S1 and a source line S2 extend in the second direction Y, and intersect the gate lines G1 and G2. The common electrode CE extends in the first direction X, and is provided over the pixels PX1 and PX2 in such a manner as to cross the source lines S1 and S2. To be more specific, the common electrode CE is provided to extend over a plurality of pixels PX adjacent to each other in the first direction, in the same manner as over the pixels PX1 and PX2. Furthermore, although it is not shown, the common electrode CE may be formed in common over a plurality of pixels arranged in the second direction Y.

In the pixel PX1, a switching element SW1 and a pixel electrodes PE1 connected to the switching element SW1 are provided. The switching element SW1 is electrically connected to the gate line G2 and the source line S1. In the pixel PX2, a switching element SW2 and a pixel electrode PE2 connected to the switching element SW2 are provided. The switching element SW2 is electrically connected to the gate line G2 and the source line S2. The switching elements SW1 and SW2 are, for example, thin film transistors (TFTs).

The pixel electrodes PE1 and PE2 are located above the common electrode CE, and formed in the shape of an island corresponding to a rectangular pixel shape. In each of the pixel electrodes PE1 and PE2, a plurality of slits PSL are formed to face the common electrode CE.

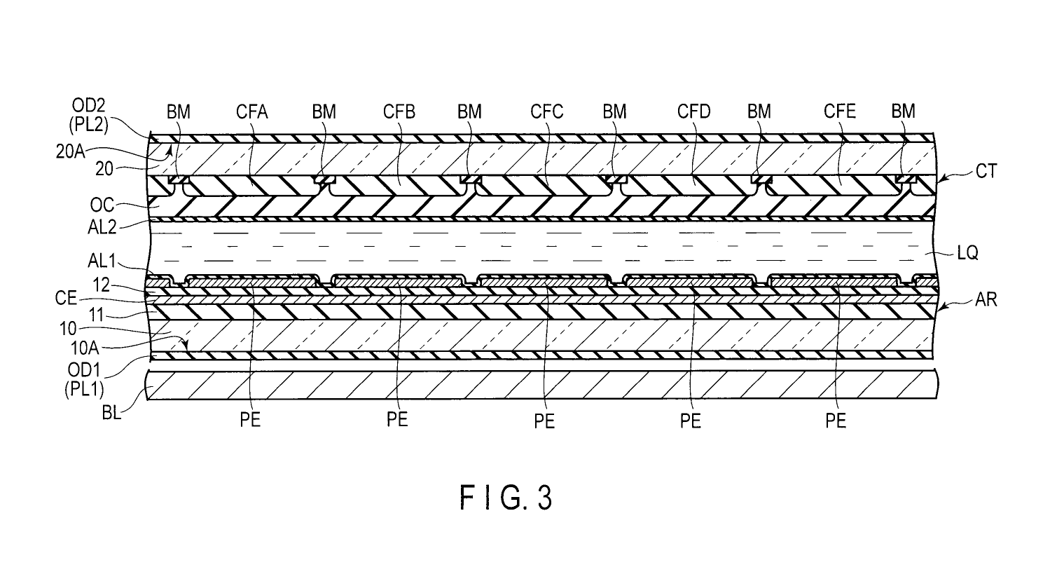

FIG. 3 is a cross-sectional view schematically showing a structure of the display panel PNL included in the liquid crystal display device according to the embodiment.

The array substrate AR is formed to include a first glass substrate 10 which is transparent, such as a glass substrate. The array substrate AR comprises a switching element not shown, the common electrode CE, the pixel electrodes PE, etc., on a side of the first glass 10 which is located opposite to the counter-substrate CT.

The common electrode CE is formed on a first insulating film 11. Also, the common electrode CE is formed of transparent conductive material such as indium tin oxide (ITO) or indium zinc oxide (IZO). The common electrode CE is covered by a second insulating film 12.

The pixel electrodes PE are formed on the second insulating film 12, and located opposite to the common electrode CE. In the pixel electrodes PE, as described above, the slits are formed; however, their detail structures are not shown. The pixel electrodes PE are formed of transparent conductive material such as ITO or IZO. The pixel electrodes PE are covered by a first alignment film AL1. The first alignment film AL1 also covers the second insulating film 12. Also, the first alignment film AL1 is formed of material exhibiting horizontal orientation, and located on part of the array substrate AR which contacts the liquid crystal layer LQ.

On the other hand, the counter-substrate CT is formed to include a second glass substrate 20 which is transparent, such as a glass substrate. On a side of the second glass substrate 20 which is located opposite to the array substrate AR, the counter-substrate CT comprises a light shielding layer BM, a first color filter CFA, a second color filter CFB, a third color filter CFC, a fourth color filter CFD, a fifth color filter CFE, an overcoat layer OC, etc.

The light shielding layer BM is formed on an inner surface of the second glass substrate 20. Also, the above first to fifth color filters are formed on the inner surface of the second glass substrate 20.

The overcoat layer OC covers the first to fifth color filters, i.e., it covers irregularities of the first to fifth color filters to form a flat surface. The overcoat layer OC is formed of transparent resin material. Also, the overcoat layer OC is covered by a second alignment film AL2. The second alignment film AL2 is formed of material exhibiting horizontal orientation, and located on a surface of the counter-substrate CT which contacts the liquid crystal layer LQ.

The array substrate AR and the counter-substrate CT are provided such that the first alignment film AL1 and the second alignment film AL2 face each other. In this case, as described above, between the array substrate AR and the counter-substrate CT, the predetermined cell gap is formed by the spacer not shown. The array substrate AR and the counter-substrate CT are bonded to each other by seal material, with the cell gap provided. The liquid crystal layer LQ is formed of a liquid crystal constituent containing liquid crystal molecules LM enclosed in the cell gap provided between the first alignment film AL1 of the array substrate AR and the second alignment film AL2 of the counter-substrate CT.

On a rear surface side of the display panel PNL having the above structure, a backlight BL is provided. As the backlight BL, various kinds of backlights can be applied. A detailed explanation of a structure of the backlight BL will be omitted.

On an outer surface of the array substrate AR, i.e., an outer surface side 10A of the first glass substrate 10, a first optical element OD1 including a first polarizer layer PL1 is provided. On an outer surface of the counter-substrate CT, i.e., an outer surface side 20A of the second glass substrate 20, a second optical element OD2 including a second polarizer layer PL2 is provided.

It should be noted that the structure of the display panel is not limited to such a structure as shown in FIG. 3, and the first optical element OD1 and the second optical element OD2 can be interchanged. For example, it may be set that the first optical element OD1 is provided on the outer surface side 20A of the second glass substrate 20, and the second optical element OD2 is provided on the outer surface side 10A of the first glass substrate 10. That is, it suffices that one of the first optical element OD1 and the second optical element OD2 is made to adhere to one of the first glass substrate 10 and the second glass substrate 20, and the other is made to adhere to the remaining glass substrate.

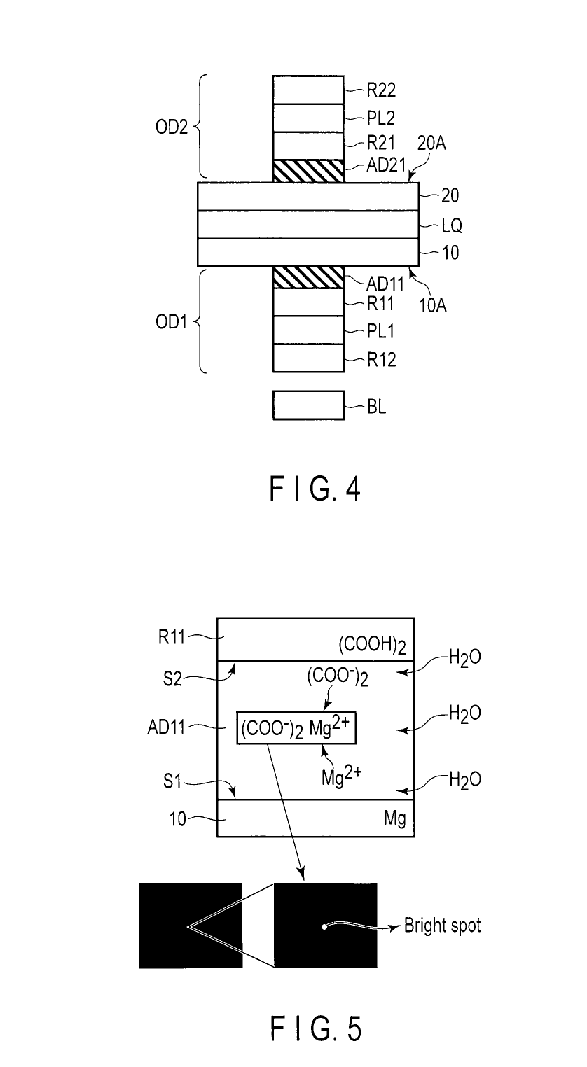

FIG. 4 is a cross-sectional view schematically showing structures of the first optical element OD1 and the second optical element OD2 according to the embodiment.

In the example shown in FIG. 4, the first optical element OD1 includes a first supporting layer R11 provided on the outer surface side 10A of the first glass substrate 10, a first polarizer layer PL1 stacked on the first supporting layer R11, and a first adhesion layer AD11 which adheres the first supporting layer R11 to the outer surface side 10A of the first glass substrate 10. The second optical element OD2 includes a second supporting layer R21 provided on the outer surface side 20A of the second glass substrate 20, a second polarizer layer PL2 stacked on the second supporting layer R21, and a second adhesion layer AD21 which adheres the second supporting layer R21 to the outer surface side 20A of the second glass substrate 20. In the example shown in FIG. 4, the first optical element OD1 further includes a third supporting layer R12 stacked on the first polarizer layer PL1. That is, the first polarizer layer PL1 is held between the first supporting layer R11 and the third supporting layer R12. Also, the second optical element OD2 further includes a fourth supporting layer R22 stacked on the second polarizer layer PL2. That is, the second polarizer layer PL2 is held between the second supporting layer R21 and the fourth supporting layer R22.

The first polarizer layer PL1 and the second polarizer layer PL2 are formed of, e.g., polyvinyl alcohol (PVA). The first supporting layer R11, the second supporting layer R21, the third supporting layer R12 and the fourth supporting layer R22 are formed of triacetylcellulose (TAC), cycloolefinpolymer (COP), acrylic material or the like.

A surface of the first supporting layer R11 which contacts the first adhesion layer AD11 may be subjected to surface processing for improving its adherence or preventing it from being charged with electricity. This surface processing includes modification of the surface of the first supporting layer R11, formation of another film on the surface of the first supporting layer R11, etc. Similarly, a surface of the second supporting layer R21 which contacts the second adhesion layer AD21 may be subjected to the above surface processing.

With respect to the first optical element OD1, it is preferable that layers close to the first glass substrate 10, i.e., the first adhesion layer AD11 and the first supporting layer R11, should not contain material having an oxidation-reduction action. As such material, for example, an oxidizing agent which acts to elute positive ions from the first glass substrate 10 or acts to promote ionization, a reducing agent which acts to elute negative ions from the first adhesion layer AD11 or acts to promote ionization or the like can be applied. Similarly, with respect to the second optical element OD2, it is preferable that layers close to the second glass substrate 20, i.e., the second adhesion layer AD21 and the second supporting layer R21, should not contain material having an oxidation-reduction action.

With respect to the first optical element OD1, it is preferable that a layer contacting the first glass substrate 10, i.e., the first adhesion layer AD11, should contain acid which captures ions eluted from the first glass substrate 10. Thus, if positive ions are eluted from the first glass substrate 10, preferably, the above layer should contain, for example, acrylic as acid capturing the positive ions. Similarly, in the second optical element OD2, it is preferable that a layer contacting the second glass substrate 20, i.e., the second adhesion layer AD21, should contain acid which captures ions eluted from the second glass substrate 20.

With respect to the first optical element OD1, it is preferable that the layers close to the first glass substrate 10, especially, the first supporting layer R11, should be formed of cycloolefinpolymer which contains a lower percentage of oxalic acid than that of acrylic material. Similarly, with respect to the second optical element OD2, it is preferable that the layers close to the second glass substrate 20, especially, the second supporting layer R21, should be formed of cycloolefinpolymer, which contains a lower percentage of oxalic acid than that of acrylic material. If the first supporting layer R11 or the second supporting layer R21 is formed of cycloolefinpolymer, it can be made to function as a phase difference layer, in addition to as a support body for its associated polarizer layer.

FIG. 5 is a view schematically showing an example of a formation process of a bright spot.

An example shown in FIG. 5 is provided as a process of formation of a bright spot which can be formed in the first glass substrate 10, the first adhesion layer AD11 and the first supporting layer R11. It should be noted that formation of the bright spot is a phenomenon in which although light from the backlight passes through the first optical element and the liquid crystal display panel and is absorbed by the second optical element to achieve a black display, part of the light passes through the second optical element and is visually recognized as a bright spot.

If the first adhesion layer AD11 contains material having an oxidation-reduction action, when the first adhesion layer AD11 absorbs water (H₂O), materials contained in an interface (first adhesion surface) S1 between the first adhesion layer AD11 and the first glass substrate 10 and an interface (second adhesion surface) S2 between the first adhesion layer AD11 and the first supporting layer R11 are ionized and eluted into the first adhesion layer AD11. For example, if magnesium (Mg) is contained in the first glass substrate 10, magnesium ions Mg²⁺ in the first glass substrate 10 are eluted from the first adhesion surface S1 into the first adhesion layer AD11. If oxalic acid (COOH)₂ is contained in the first supporting layer R11, oxalic acid ions (COO⁻)₂ in the first supporting layer R11 are eluted from the second adhesion surface S2 into the first adhesion layer AD11. It should be noted that a reaction of ionization of materials in the first adhesion surface S1 and the second adhesion surface S2 will be referred to as an oxidation-reduction reaction. Due to the oxidation-reduction reaction, magnesium ions Mg²⁺ and oxalic acid ions (COO⁻)₂ eluted into the first adhesion layer AD11 are bonded to each other to form oxalic acid magnesium (COO)₂. Oxalic acid magnesium (COO)₂ formed in the first adhesion layer AD11 can cohere, e.g., in the vicinity of the second adhesion surface S2, and become impurities which disturb polarization of light passing through the first adhesion layer AD11. That is, plane polarized light passing through a region where oxalic acid magnesium (COO)₂ coheres and plane polarized light passing through a region where oxalic acid magnesium (COO)₂ does not cohere are different from each other in polarized state. Thus, of the plane polarized light passing through the first polarizer layer PL1, the plane polarized light passing through the region where oxalic acid magnesium (COO)₂ does not cohere is absorbed by the second polarizer layer PL2 (a black display is obtained), and the plane polarized light passing through the region where oxalic acid magnesium (COO)₂ coheres is not absorbed by the second polarizer layer PL2, and passes through the second optical element OD2. Such a process is gone through to form a bright spot.

It should be noted that the above explanation is given with respect to a formation process of a bright spot which can be generated in the first glass substrate 10, the first adhesion layer AD11 or the first supporting layer R11; however, similarly, a bright spot can also be formed in the second glass substrate 20, the second adhesion layer AD21 or the second supporting layer R21, but its detail explanation will be omitted.

According to the embodiment, neither the first adhesion layer AD11 not the first supporting layer R11 contains material having an oxidation-reduction action, and thus neither the first adhesion surface S1 nor the second adhesion surface S2 contains material having an oxidation-reduction action. It is therefore possible to restrict occurrence of an oxidation-reduction reaction at the first glass substrate 10 and the first supporting layer R11 through the first adhesion layer AD11. Thus, it is possible to restrict generation of impurities in the first adhesion layer AD11, and thus also restrict formation of a bright spot which would occur due to cohesion of impurities. Therefore, the display quality can be improved.

Furthermore, in the case where the first adhesion layer AD11 is made to contain acid which captures ions eluted from the first glass substrate 10, even if ions are eluted from the first glass substrate 10, they are captured, and generation of impurities can thus be restricted.

In addition, in the case where material containing a low percentage of oxalic acid (for example, cycloolefinpolymer (COP)) is applied as material of the first supporting layer, elution of oxalic acid from the first supporting layer R11 itself is restricted, and generation of impurities is restricted.

Next, it will be described with respect to an experiment in which the display quality of each of display panels was measured after each display panel was left for approximately 500 hours in an environment of high temperature and high humidity (for example, a temperature of 65° C. and humidity of 90%).

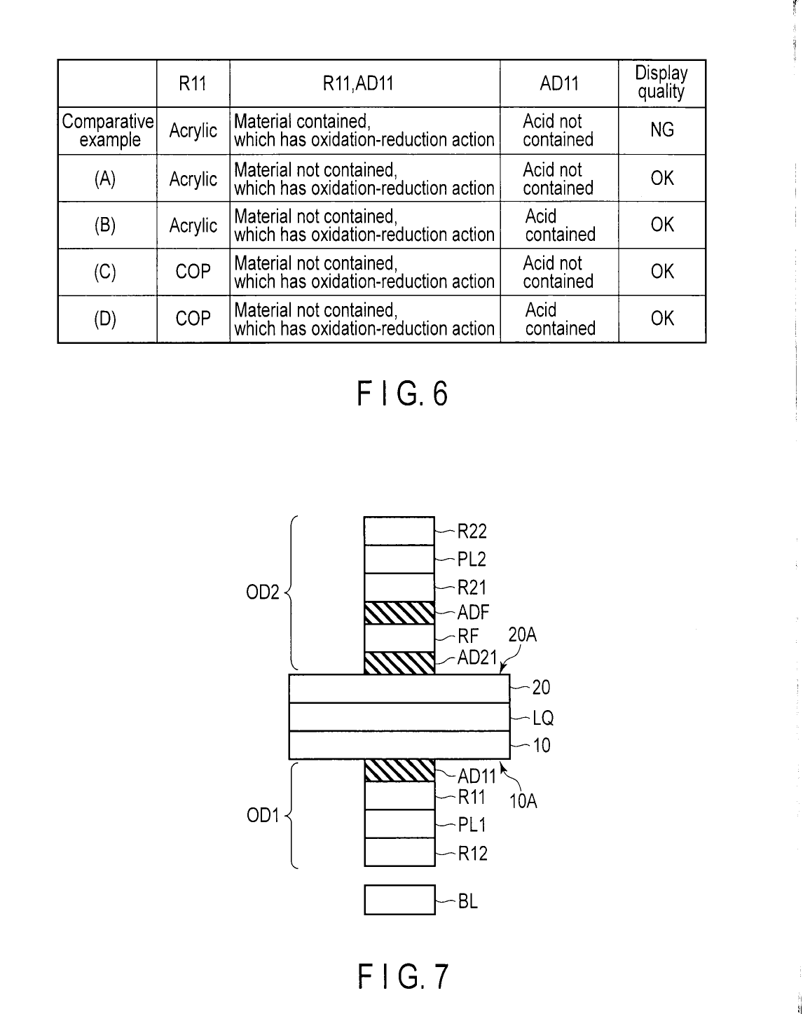

FIG. 6 is a view for explaining a result of the experiment with respect to a comparative example and embodiments. With respect to a display quality indicated in FIG. 6, “NG” means that a display panel is considered defective based on the number of bright spots formed, and “OK” means that a display panel is considered normal.

In the experiment, display panels according to embodiments (A)-(D) and a display panel of the comparative example were prepared, and their display qualities were measured. Unlike the embodiments (A)-(D), the comparative example includes no elements for reducing the number of bright spots.

To be more specific, in the comparative example, a first supporting layer R11 is formed of acrylic material, a first supporting layer R11 and a first adhesion layer AD11 each contain material having an oxidation-reduction action, and a first adhesion layer AD11 does not contain acid which captures ions. According to the result of the experiment, the display quality of the comparative example is determined as “NG”, since a large number of bright spots are formed.

In the embodiment (A), a first supporting layer R11 is formed of acrylic material, neither a first supporting layer R11 nor a first adhesion layer AD11 contains material having an oxidation-reduction action, and a first adhesion layer AD11 does not contain acid which captures ions. According to the result of the experiment, the display quality of the embodiment (A) is determined as “OK”, since the number of bright spots formed is very small.

In the embodiment (B), a first supporting layer R11 is formed of acrylic material, neither a first supporting layer R11 nor a first adhesion layer AD11 contains material having an oxidation-reduction action, and a first adhesion layer AD11 contains acid which captures ions. According to the result of the experiment, the display quality of the embodiment (B) is determined as “OK”, since the number of bright spots formed is smaller than that of the embodiment (A).

In the embodiment (C), a first supporting layer R11 is formed of cycloolefinpolymer (COP), neither a first supporting layer R11 nor a first adhesion layer AD11 contains material having an oxidation-reduction action, and a first adhesion layer AD11 does not contain acid which captures ions. According to the result of the experiment, the display quality of the embodiment (C) is determined as “OK”, since the number of bright spots formed is further smaller than that of the embodiment (A).

In the embodiment (D), a first supporting layer R11 is formed of cycloolefinpolymer (COP), neither a first supporting layer R11 nor a first adhesion layer AD11 contains material having an oxidation-reduction action, and a first adhesion layer AD11 contains acid which captures ions. According to the result of the experiment, the display quality of the embodiment (D) is determined as “OK”, since the number of bright spots formed is smaller than that of any of the embodiments (A)-(C); that is, it is the smallest in all the embodiments.

From such a result of the experiment, it is confirmed that according to the embodiments, it is possible to restrict the number of bright spots even in an environment of high temperature and high humidity.

Then, another example (modification) of the layout will be explained.

FIG. 7 is a cross-sectional view schematically showing structures of optical elements in a modification of the embodiment.

Unlike the example shown in FIG. 4, in an example shown in FIG. 7, a phase difference layer RF is held between a second supporting layer R21 and a second adhesion layer AD21. The phase difference layer RF is adhered to the second supporting layer R21 by an adhesion layer ADF.

It is preferable that the phase difference layer RF and the second adhesion layer AD21 should not contain material having an oxidation-reduction action, as described above, since they are located close to a second glass substrate 20.

In such a modification also, the same advantage as in the above embodiments can be obtained.

As explained above, according to the embodiments, it is possible to provide a liquid crystal display device in which a display quality can be improved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A liquid crystal display device comprising:
a liquid crystal display panel in which a liquid crystal layer is held between a first glass substrate and a second glass substrate which are located opposite to each other;
a first optical element including a first supporting layer, a first polarizer layer and a first adhesion layer, the first supporting layer being provided on an outer surface side of the first glass substrate, the first polarizer layer being stacked on the first supporting layer, the first adhesion layer adhering the first supporting layer to the outer surface side of the first glass substrate; and
a second optical element including a second supporting layer, a second polarizer layer and a second adhesion layer, the second supporting layer being provided on an outer surface side of the second glass substrate, the second polarizer layer being stacked on the second supporting layer, the second adhesion layer adhering the second supporting layer to the outer surface side of the second glass substrate,
wherein the first supporting layer and the first adhesion layer are each formed of material which does not cause an oxidization-reduction action.

2. The liquid crystal display device of claim 1, wherein the first adhesion layer contains acid which captures ions eluted from the first glass substrate.

3. The liquid crystal display device of claim 1, wherein the first supporting layer is formed of cycloolefinpolymer.

4. The liquid crystal display device of claim 3, wherein the first supporting layer is a phase difference layer.

5. The liquid crystal display device of claim 1, wherein the second adhesion layer contains acid which captures ions eluted from the second glass substrate.

6. The liquid crystal display device of claim 1, wherein the second supporting layer is formed of cycloolefinpolymer.

7. The liquid crystal display device of claim 6, wherein the second supporting layer is a phase difference layer.

8. The liquid crystal display device of claim 1, wherein the second supporting layer and the second adhesion layer are each formed of material which does not cause an oxidization-reduction action.

9. The liquid crystal display device of claim 1, wherein the first supporting layer is formed of material which contains a lower percentage of oxalic acid than that of acrylic material.

10. The liquid crystal display device of claim 1, wherein the second supporting layer is formed of material which contains a lower percentage of oxalic acid than that of acrylic material.

11. The liquid crystal display device of claim 1, wherein the second optical element further includes a phase difference layer and a third adhesion layer, the phase difference layer being located between the second supporting layer and the second adhesion layer, the third adhesion layer adhering the phase difference layer to the second supporting layer.

12. The liquid crystal display device of claim 11, wherein the phase difference layer is formed of material which does not cause an oxide-reduction action.
